(19) United States
(12) Patent Application Publication
(10) Pub. No.: US 2013/0313465 A1
(43) Pub. Date: Nov. 28, 2013

(54) FIRE FIGHTING AND FIRE RETARDANT COMPOSITIONS

(71) Applicant: ADVANCED BIOCATALYTICS CORP., IRVINE, CA (US)

(72) Inventors: Carl W. PODELLA, Irvine, CA (US); John W. BALDRIDGE, Irvine, CA (US); Michael G. GOLDFELD, Irvine, CA (US); William WENDEL, Hiawassee, GA (US)

(21) Appl. No.: 13/900,449

(22) Filed: May 22, 2013

Related U.S. Application Data
(60) Provisional application No. 61/650,396, filed on May 22, 2012.

(51) Int. Cl. A62D 1/02

(52) U.S. Cl. CPC A62D 1/0078
USPC 252/3

(57) ABSTRACT

Disclosed herein are fire-fighting compositions, and methods thereof, comprising a surfactant and a fraction of a fermentation mixture comprised of yeast exoproteins, where the proteins enhance ability of water to extinguish Class A, Class B and Class K fires, as defined by the National Fire Protection Association. In one embodiment the surfactant is optimized to wet and penetrate into the substrate, for example wood, as in a Class A fire. In a second embodiment, the surfactant is optimized for foaming to provide fire fighting protection in a Class B fire. Further embodiments include methods for using the same protein-surfactant fire fighting composition for both polar (e.g., alcohol) and non-polar combustible liquids. In yet another embodiment, methods are described where the proteins comprise stress shock proteins and where the residual protein-surfactant combination that is not degraded from the fire acts to stimulate resident bacterial populations to accelerate the biodegradation of residual hydrocarbons and surfactants from the composition. In another embodiment, the compositions are free of solvents, fluorine-free as in fluoro surfactants and fluoro-polymers.

### RELATED APPLICATION

The present application claims priority to the U.S. Provisional Application Ser. No. 61/650,396, filed May 22, 2012, and entitled “FIRE FIGHTING AND FIRE RETARDANT COMPOSITIONS,” the entire disclosure of which is incorporated by reference herein.

### FIELD OF THE INVENTION

The current invention is in the field of fire-fighting and fire retardant compositions, including both non-polar and polar combustible liquids, and combustible materials such as paper, wood, cloth, fabric, leaves, grass and shrubbery, etc., not including gases.

### BACKGROUND OF THE DISCLOSURE

Surfactants have been used as fire-fighting agents for several decades. Surfactants have minimal heat absorbing utility and are used with water, which is the primary means of absorbing heat in a fire.

Surfactants provide two key characteristics as additives to water for fighting fires. First, surfactants improve wetting characteristics so that the water may penetrate into a porous substrate, where more of it is available to absorb heat. Improved wetting also helps to retain water in a substrate on vertical surfaces. In addition, improved penetration into porous surfaces helps to prevent re-ignition of fires that had been extinguished by leaving heat absorbing water in the porous material. These are characteristics generally important in Class A fires as defined by the National Fire Protection Association (NFPA). For example, a common porous material is wood. Structures composed of wood, either processed from trees or the trees per se, improved penetration would be extremely beneficial in firefighting efforts.

Second, surfactants create foam and foam acts to form a blanket in Class A, Class B and Class K fires. Polymers and inorganic materials are added to various fire fighting products to improve foam integrity. The foam prevents oxygen in the air from coming into contact with a combustible liquid, and also tends to smother a fire. The foam blanket reduces the ability of volatile gases to escape into the air where they can ignite. The United States military and aircraft applications fall under similar requirements or needs for fire extinguishing chemicals.

### Class A Fires—Wetting Agents

The NFPA defines Class A fires are those that include ordinary combustible material, such as wood, paper, plastics, rubber and do not involve liquids and gases. Class A fires can be extinguished with water in many instances and may not require special agents to be added to the water, especially if their effectiveness is perceived to be minimal.

Surfactants are generally limited in their ability to improve the extent or degree of wetting to the level that is needed for effective improvement in fighting Class A fires. The surface tension reduction caused by surfactants is limited as to how well they will wet and penetrate a material. Most wetting agents and Class A foaming agents therefore use solvents to improve wetting and penetration characteristics. The negative aspects of solvents are their environmental impact. Solvents typically include compounds such as glycol ethers. These compounds have toxicity issues and they tend to be Volatile Organic Compounds.

Spraying foam on surfaces in Class A fires can improve extinguishing characteristics and a robust foam blanket can prevent re-ignition. A thick foam blanket requires specialized nozzles to create the foam. In many instances, however, it is not convenient for fire fighters to use specialized nozzles to spray foam onto Class A fires, such as buildings. The nozzles work based on restricted flow and the idea of reducing water flow goes against the intent to get the optimal amount of water to a fire.

It would be a benefit to have an effective wetting and penetrating surfactant that foams naturally without special nozzles that would improve fire fighting efficiency.

In many instances where a fire has been extinguished on a particular surface, the heat remaining in the area could cause the fire to reignite. It is therefore important to create a fire extinguishing composition that will also act as a fire retardant, where the tendency for re-igniting is reduced. For example, improved penetration of water into wood and other porous materials will help to prevent re-ignition of extinguished surfaces.

### Class B Fires

Class B fires are defined as those involving flammable, combustible liquids. Fire retardants for this class of combustibles have largely been based on foam forming compositions. Aqueous Film Forming Foams (AFFF) are typically based on fluorosurfactants and have an exceptional ability to form a barrier film on a flammable surface or hydrocarbon. They further comprise hydrocarbon surfactants and/or solvents to improve their wetting characteristics and spreading coefficient

U.S. Pat. No. 6,527,970 teaches that hydrocarbon surfactants can be substituted with a glycol ether, diethylene glycol mono-butyl ether, when mixed with AFFF fluorosurfactants, to improve the fire retarding performance for Class B fires.

For certain types of fires, such as those fueled by MTBE (methyl tertiary butyl ether), which has been used as a gasoline additive, the use of hydrolyzed proteins are recommended to improve foaming characteristics. They are typically based on soy proteins. It is important at this point to distinguish between the yeast exoproteins and stress shock proteins, which are the basis of the current invention, as being different than the typical hydrolyzed “proteins” used to enhance foaming and foam robustness in conventional fire retarding compositions.

Class B fires that are based on polar solvents, such as ethyl alcohol, require the addition of compounds that will not destroy the foam blanket. When alcohol evaporates in a fire it tends to break down foams created by AFFF fire fighting products. To solve this problem, the addition of polymers is required for polar solvent fires, where the polymer creates a blanket to prevent the evaporating vapors from penetrating into the foam layer.

The fluorosurfactants and solvents used in Class B fire fighting formulations create environmental issues. In the United States and many parts of Europe, the use of fluorine compounds in fire-fighting agents are being regulated out of use due to their environmental impact. There is a need in the fire-fighting field for a fire-fighting composition that eliminates the need for fluorsurfactants and solvents, yet possesses similar, if not identical foaming and fire fighting characteristics. High molecular weight fluoro-polymers were developed as alternates that exhibit a smaller environmental footprint than fluorosurfactants, but they still expose the environment to fluorine, which can have long term negative consequences.

In an effort to improve the environmental signature of fire fighting agents are efforts such as reflected in U.S. Pat. No. 6,527,970 (Scogin), which comprises a mixture of microorganisms in the fire-fighting composition for remediation purposes: “contains surfactants to disperse and extinguish the fire and facilitate the decomposition of the volatile organic compounds by the microbe cultures.”

U.S. Pat. No. 7,172,709 describes fire-fighting compositions that are fluorine-free and thus mitigate the environmental issues of fluorine. “These compositions include synthetic liquid concentrates stabilized with high molecular weight acidic polymers (HMWAP) and coordinating salt(s), which extinguish non-polar Class B fires.” Water soluble film formers need to be added to form AR (alcohol resistant) agents. Alcohol as a combustible breaks down foam rapidly and polymer additives are typically required to develop the barrier between the foam and the liquid.

A fire fighting agent which would be effective with both polar and non-polar solvents, be fluorine free either as fluorosurfactants or fluoro-polymers, would benefit fire fighting efforts by simplifying the inventory of such agents and improving the environmental impacts.

### Class K Fires

Fires are associated with cooking oils and greases are designated as Class K by the NFPA and Class F in the European/Australian/Asian systems. It has been shown by the Assignee of the current invention that the protein and surfactant compositions, noted as ESC in the current invention, have the ability to break down oils and greases in sterile conditions. It is believed, that like traditional alkaline surfactant systems that saponify food oils, the compositions of the current invention have an analogous mechanism for helping to extinguish fires associated with cooking oils. This mechanism, is however a hyphothesis that has not been proven and is not a limiting factor in the current invention.

### SUMMARY OF THE INVENTION

Disclosed herein are fire-fighting compositions, and methods thereof, comprising a surfactant and a fraction of a fermentation mixture comprised of yeast exoproteins, where the proteins enhance ability of water to extinguish Class A, Class B and Class K fires, as defined by the National Fire Protection Association.

### DETAILED DESCRIPTION OF THE EMBODIMENTS

It has been found that the fermentation of yeast produces certain exoproteins that can enhance the wetting characteristics of surfactants and are cited, for example, in the following patents and applications: U.S. Pat. Nos. 6,699,391, 7,165,561, 7,476,529, 7,659,237, 7,658,848, the disclosure of which is incorporated by reference herein in their entirety. The compositions combining the exoproteins with surfactants provide beneficial features in fire fighting remediation applications. The protein systems disclosed herein can also be derived from the fermentation of various yeast species, for example, saccharomyces cerevisiae, kluyveromyces marxianus, kluyveromyces lactis, candida utilis, zygosaccharomyces, pichia, or hansanula. The proteins and surfactant combinations are synergistic and the exo-proteins of the current invention can be termed Protein Surfactant Synergists.

The present disclosure relates to compositions and methods developed based on the finding exoprotein and surfactant compositions (ESC) improve on typically used wetting agents and Class A foaming agents by using compounds that are environmentally and toxicologically benign. Further, the ESC improves on the wetting performance, which improves fire fighting effectiveness, and is notably effective on wood substrates.

In another aspect, disclosed herein are methods and compositions that improve the penetration of water into porous substances, such as wood, thereby significantly reducing, if not totally eliminating, the tendency to re-ignite after a fire has been extinguished.

Another benefit of the methods and compositions disclosed herein is that an appropriate ESC mixture can be effective on fires involving both polar and non-polar solvents.

In one aspect, disclosed herein are versatile, fluorine-free, fire-fighting formulations, based on yeast exoproteins and surfactants, where the formulations meet or exceed military requirements, industrial requirements and UL requirements for use on Class A, Class B or Class K fires as specified in UL162, or as specified by military, aircraft and other industrial regulatory bodies with analogous fire extinguishing needs. By fluorine-free, the invention specifies that no fluorine surfactants, fluorine polymers or other fluorine based polymers need to be used in the compositions and will meet the fire fighting performance of conventional FluoroPolymer (FP), AFFF or AR-AFFF formulations.

The yeast exoproteins were derived as a fraction of a fermentation mixture, where preferably, aerobic fermentation is used, essentially defined in U.S. Pat. Nos. 7,645,703 and 7,476,529. These patents are incorporated by reference herein in their entirety, and specifically the passages in these patents relating to the post-fermentation shocking of the fermentation mixture and obtaining the stress proteins. In some embodiments, the exoproteins are subjected to heat shock to optimize the formation of stress shock proteins for improved performance and for accelerating the degradation of surfactants and other organic compounds used in the fire extinguishing formulations.

In certain embodiments, the exoproteins are combined with surfactants. In some embodiments, the following are appropriate classes of surfactants that can be considered for optimization in particular end used, but for the purposes of the current invention, are not limited to those listed.

Anionic: Sodium linear alkylbenzene sulfonate (LABS); sodium lauryl sulfate; sodium lauryl ether sulfates; petroleum sulfonates; linosulfonates; naphthalene sulfonates, branched alkylbenzene sulfonates; linear alkylbenzene sulfonates; fatty acid, alkylolamide, sulfosuccinate; alcohol sulfates.

Cationic: Stearalkonium chloride; benzalkonium chloride; quaternary ammonium compounds; amine compounds; ethosulfate compounds.

Non-ionic: Dodecyl dimethylamine oxide; coco diethanol-amide alcohol ethoxylates; linear primary alcohol polyethoxylate; alkyl phenol ethoxylates; alcohol ethoxylates; EO/PO polyol block polymers; polyethylene glycol esters; fatty acid alkanolamides.

Amphoteric: Cocoamphocarboxyglycinate; cocamidopropyl betaine; betaine derivatives; imidazolines.

In addition to those listed above, suitable nonionic surfactants include alkanolamides, amine oxides, block polymers, ethoxylated primary and secondary alcohols, ethoxylated alkyl phenols, ethoxylated fatty esters, sorbitan derivatives, glycerol esters, propoxylated and ethoxylated fatty acids, alcohols, and alkyl phenols, alkyl glucoside glycol esters, polymeric polysaccharides, sulfates and sulfonates of ethoxylated alkyl phenols, and polymeric surfactants. Suitable anionic surfactants include ethoxylated amines and/or amides, sulfosuccinates and derivatives, sulfates of ethoxylated alcohols, sulfates of alcohols, sulfonates and sulfonic acid derivatives, phosphate esters, and polymeric surfactants. Suitable amphoteric surfactants include betaine derivatives. Suitable cationic surfactants include amine surfactants. Those skilled in the art will recognize that other and further surfactants are potentially useful in the compositions depending on the particular application.

A key characteristic of fire fighting products is the ability to form a foam blanket. As is disclosed herein, it was found that surfactants, such as amine oxides help to improve the formation of foams in terms of foam volume, density and stability. One of the benefits of the yeast exoproteins, when added to surfactants, is their ability to improve foam quality. The versatility of the exoproteins disclosed herein allows the formulator to optimize the surfactant to be used for a specific application. The surfactants used in the examples show capability, but do not limit what can be added.

### Yeast Extracts

Yeast exo-proteins are defined as species that are produced by fermentation, and any of a number of known processes can be used to produce the exo-proteins, with either aerobic or anaerobic fermentation. Virtually all any carbohydrate and nutrient combinations that allow yeast to grow during fermentation can be used. Aerobic processes are preferred due to shorter fermentation time, which can lower costs. In some embodiments, the yeast exoproteins disclosed herein comprise heat shock proteins, or stress proteins.

Stress proteins are produced by yeast as a response to chemical, thermal, radiation, or mechanical stress that cause certain genes to be expressed by the yeast, therefore stimulating their production of compounds in a fermentation process that can be either anaerobic or aerobic. Yeast extracts have been long known for their use in skin care as live yeast cell derivative, or LYCD as per Sperti in U.S. Pat. Nos. 2,320,478 and 2,320,479, using an alcohol extraction process with baker's yeast that kills the yeast cells used for extraction from alcohol and temperature lysis. The presently disclosed compositions and methods do not require that the yeast be killed, as the exoproteins are produced by yeast as a response to stress signals. Furthermore, the costs of purifying and isolating LYCD are high and for the purposes of combining the yeast extract with enzymes, the entire supernatant from a yeast fermentation process can potentially be utilized.

In particular, heat has been shown to be a simple, repeatable source of stress for yeast exoprotein production. The presently disclosed compositions and methods take advantage of proteins derived from yeast fermentation, including so-called heat shock proteins, in U.S. Pat. Nos. 7,476,529, No. 7,645,730, No. 7,659,237 and No. 7,759,301. “Prior to centrifugation, the yeast in the fermentation product is subjected to heat-stress conditions by increasing the heat to between 40 and 60 degrees C., for 2 to 24 hours, followed by cooling to less than 25 degrees C.” The thermal stress can be done at lower or higher temperatures, depending on the overall process and particular strain of yeast being used. Saccharomyces C. can start to die off at about 70 degrees C., and it is assumed that at some point near this temperature they would stop excreting any proteins. Heat shock proteins are also known as stress proteins, a result of exposing yeast to stress conditions that include heat, chemical or mechanical stress. [Heat shock proteins: modifying factors in physiological stress responses and acquired thermotolerance. Kevin C. Kregel (2001) J. Applied Physiol. v. 92(5), pp.2177-2186] Thus defined, yeast exo-proteins have properties related to the following, with optimal benefits when they contain stress proteins:

(a) improving surfactant performance in terms of lowering interfacial tension, surface tension, critical micelle concentration, improving wetting, penetration and uptake of solutions and their ingredients by various materials, and

(b) accelerating microbial, mostly, but not exclusively aerobic, metabolic rates with a mechanism shown to rely, at least partially, on uncoupling of oxidative phosphorylation in bacterial cells.

In one embodiment, a yeast fermentation product that contains yeast exoproteins is combined with one or more of either an anionic, nonionic, cationic or amphoteric surfactant, and where the protein and surfactant composition acts as a wetting agent to improve wetting of combustible surfaces to improve water penetration, and subsequently improves fire fighting effectiveness. In an alternative composition, a fluoropolymer used in AFFF formulations is added to improve fire fighting effectiveness.

In another embodiment, disclosed is a method of using the exoprotein and surfactant composition to improve wetting of substrate materials to accelerate the time to extinguishing a fire.

In a further embodiment, disclosed is a method where the improved penetration of water into a porous substrate, such as wood, hay, raw and dried vegetation, fabric, and the like, and allows the penetrating water to act as a fire retardant and to reduce the tendency for the fire to reignite. In another embodiment, the improved wetting of substrate prevents re-ignition.

In another embodiment, is a method of adding the exprotein and surfactant composition to water in a proportion that is optimal in its ability to create a foam and for improving the fire fighting effectiveness of Class B fires, where one formulation can be used for both polar and non-polar based fires.

In another embodiment, the residual exoproteins are derived by subjecting them to stress shock, forming essentially stress shock proteins that are combined with a surfactant and added to water in an optimal proportion where the protein and surfactant, which is not consumed by the heat of the fire, interacts with the resident bacteria population to increase its metabolic activity to accelerate the breakdown of the surfactants used in the fire fighting agents. The formulation may include nutrients to promote the growth of microflora that would digest the organic materials.

In another embodiment, the exoproteins are derived from an aerobic fermentation process.

In another embodiment, the improved wetting agent comprises an anionic surfactant and stress proteins.

In another embodiment the exoprotein and surfactant composition is foam fire fighting agent, essentially for Class B and/or Class K fires.

In another embodiment, the anionic surfactant is one or combination of the following: sodium dioctylsulfosuccinate.

What is claimed is:

1. A fire fighting composition comprising a surfactant and a yeast exo-protein derived from yeast fermentation, wherein the composition accelerates the extinguishing of a fire.

2. The composition of claim 1 where the fermentation is either aerobic or anaerobic.

3. The composition of claim 1 where the surfactant comprises one or more of either an anionic, nonionic, cationic or amphoteric surfactant.

4. The composition of claim 1 that further comprises a fluorine compound, that includes the following, or combinations thereof: a fluorosurfactant, a high molecular weight fluoropolymer, and the like.

5. The composition of claim 3 where the surfactant is taken from the following, including combinations thereof, but not limited to: (a) Anionic: Sodium linear alkylbenzene sulfonate (LABS); sodium lauryl sulfate; sodium lauryl ether sulfates; petroleum sulfonates; linosulfonates; naphthalene sulfonates, branched alkylbenzene sulfonates; linear alkylbenzene sulfonates; fatty acid, alkylolamide, sulfosuccinate; alcohol sulfates. (b) Cationic: Stearalkonium chloride; benzalkonium chloride; quaternary ammonium compounds; amine compounds; ethosulfate compounds. (c) Non-ionic: Dodecyl dimethylamine oxide; coco diethanol-amide alcohol ethoxylates; linear primary alcohol polyethoxylate; alkyl phenol ethoxylates; alcohol ethoxylates; EO/PO polyol block polymers; polyethylene glycol esters; fatty acid alkanolamides. (d) Amphoteric: Cocoamphocarboxyglycinate; cocamidopropyl betaine; betaine derivatives; imidazolines.

6. The composition of claim 1, wherein the exo-protein improves the wetting and penetration of the composition into cellulosic material, including trees, hay, grass, plants, dry plants and foliage and the like.

7. The composition of claim 1, where the exo-protein improves wetting and penetration of the composition into both natural and synthetic fabric, including upholstery, clothing, carpeting, and the like.

8. The composition of claim 1, wherein an extinguished fire has reduced potential for re-ignition.

9. The composition of claim 1, wherein the composition is dispensed to create a foam blanket over combustible material.

10. The foam blanket of claim 9, wherein the foam acts as a blanket to prevent oxygen to the combustible material.

11. The composition of claim 1, wherein fire fighting is effective on both polar and non-polar combustible compounds.

12. The composition of claim 1, further comprising a nutrient for microbes.

13. The composition of claim 1, wherein the residual exo-protein and surfactant composition after application for firefighting acts to accelerate biodegradation of organic compounds including the surfactant of the composition.

14. The polar solvent of claim 11 that includes an alcohol.

15. The non-polar solvent of claim 11 that includes gasoline.
